(19) United States
(12) Patent Application Publication
(10) Pub. No.: US 2008/0233016 A1
(43) Pub. Date: Sep. 25, 2008

(54) Multichannel array as window protection

(75) Inventor: Kenneth C. Harvey, Dallas, TX (US)

Correspondence Address: RUDOLPH J. BUCHEL JR., LAW OFFICE OF, P. O. BOX 702526, DALLAS, TX, 75370-2526, US

(73) Assignee: Verity Instruments, Inc.

(21) Appl. No.: 11/726,958

(22) Filed: Mar. 21, 2007

(51) Int. Cl. B01J 19/00

(52) U.S. Cl. 422/119; 422/119

(57) ABSTRACT

A multichannel array structure is provided and a mechanism for establishing a viscous flow within the multichannel array for preventing the flow of particulates (???material) that cause window clouding. A process chamber is provided for confining a process pressure within a process volume with a viewport window along the chamber for viewing at least a portion of the process volume. A ingress port is disposed in the process chamber, and to the process volume, for receiving a flow of process gas in the process volume and an egress port is disposed, and in the process chamber, to the process volume for extracting a flow rate of gas from the process volume. A multichannel array (MCA) is disposed between the viewport window and the process volume of the process chamber. The MCA has a plurality of channels, each of the channels having a diameter and a length. A window chamber is defined between the viewport window and MCA with a chamber window port for receiving gas into the chamber volume. A viscous flow is formed at the window side of the channels in the MCA that prevents material from entering the window chamber and adhering to the window. The viscous flow is established by increasing pressure in the window chamber via the chamber window port, wherein the window chamber pressure exceeds the process pressure, but not enough to substantially increase the flow rate of gas from the process volume. The viscous flow rate is substantially lower than the flow of process gas into the process volume.

### BACKGROUND OF THE INVENTION

1. Field of the Invention

The present invention relates generally to a device for reducing the effects of clouding of an optical sensor window in a plasma environment. More particularly, the present invention relates to a system and method for implementing a mass flow in a multichannel array for reducing window clouding.

2. Description of Related Art

In the art of semiconductor processing, in order to form integrated circuit structures from wafers, selectively removing or depositing materials on a semiconductor wafer is well known. Removal of material from a semiconductor wafer is accomplished by employing some type of etching process, for instance and including reactive ion etching, deep-ion etching, sputtering etching and plasma etching. Depositing material on a wafer may involve chemical and physical vapor depositions, evaporative deposition, electron beam physical vapor deposition, sputtering deposition, pulsed laser deposition, molecular beam epitaxy and high velocity oxygen deposition. Other removal and deposition processes are known. Such processes are tightly controlled and are done in a sealed process chamber. Because exact amounts of material are deposited onto or removed from the substrate wafer, its progress must be continually and accurately monitored to precisely determine the stopping time or endpoint of a particular process. Optically monitoring the chamber processes is one very useful tool for determining the stage or endpoint for an ongoing process. For instance, the interior of the chamber may be optically monitored for certain known emission lines by spectrally analyzing predetermined wavelengths of light emitted or reflected from the target in the chamber. Typical methods are optical emission spectroscopy (OES), absorption spectroscopy, reflectometry, etc. Typically, an optical sensor or source is positioned on the exterior of the chamber and adjacent to a viewport or window, with a vantage point to the target area in the chamber to be observed.

One problem with optical monitoring chamber processes is that during many of these processes, the interior of the chamber contains alloys, polymers and reactive gases that result in deposits on the interior surfaces of the chamber, including the viewport window. Additionally, the window is subject to etching, and further degradation, by the reactive gases in the chamber. As the window becomes clouded, its optical properties are altered, which may affect the measurements by the optical sensor. While it is expected that the entire interior surface of the chamber must be cleaned of deposits from time to time, and the chamber recertified, the window must be cleaned or replaced much more frequently for maintaining consistently accurate optical measurements. Under certain conditions, the viewport window must be cleaned ten or twenty times, and the optical sensor recalibrated, between chamber cleanings. Maintaining the chamber window is time consuming, expensive and decreases the available runtime of the chamber.

Typically, the prior art handles window clouding in one of three ways to reduce the frequency between window maintenance between chamber cleaning cycles: adjusting the optical measurements to account for window clouding; in situ cleaning of the window; and preventing the optical degradation of the window. There is no single method for adjusting the optical measurements to suit all situations and processes. The success of these methods varies on a case by case basis, by the particular process, and even by the spectral wavelength being monitored for a process. In situ cleaning typically involves some mechanism for cleaning the viewport window without removing the window and with little interruption to the process schedule. One method is to direct an inert gas toward the exterior surface of the window to remove contaminants from the window. Gases such as helium and nitrogen are often used, but other, non-inert gases, may also aid in cleaning the viewport window, such as O₂. However, the use of an inert gas on a window (or any non-process gas) that is exposed to the interior of the chamber and mixes with the process gas may adversely affect the process. U.S. Pat. No. 6,052,176 to Ni, et al., entitled “Processing Chamber With Optical Window Cleaned Using Process Gas” discloses using a process gas to remove contaminants from the window. A port for the process gas is oriented parallel to the exterior window surface. The process gas flow dislodges any by-products from the surface of the window and then directs the same onto the processing chamber. U.S. Pat. No. 6,344,151 to Chen, et al., entitled “Gas Purge Protection of Sensors and Windows in a Gas Phase Processing Reactor,” discloses a gas purged viewport for endpoint detection in a gas phase processing chamber which prevents contamination of an optical monitoring window by use of a purge gas flow. The gas purge viewport includes a prechamber between the optically transparent window and the process chamber. The purge gas is passed through the prechamber and into the processing chamber to purge the window. Chen, et al. discuss using the gas purge system to purge other parts of the system, including sensors exposed to the chamber. U.S. Pat. Nos. 6,390,019 and 6,712,927 to Grimbergen, et al., entitled “Chamber Having Improved Process Monitoring Window,” disclose using energized process gas ions to energetically bombard the window and remove process residues deposited thereon. An electric field source comprises an electrode with one or more apertures which is disposed between a window and light source to provide an electric field that is perpendicular to the plane of the window and accelerate process gas ions toward the window.

The use of purge gas, even process gases, may reduce the flow of process gas to the shower and result in a detrimental affect on the process. U.S. Pat. No. 6,301,434 to McDiarmid, et al., entitled “Apparatus and Method for CVD and Thermal Processing of Semiconductor Substrates,” discloses a dual gas injection manifold which is used in a thermal processing system, which has a purge gas showerhead on its top surface and a process gas showerhead on its bottom surface. The manifold prevents unwanted deposition on the underside of the window, as well as injects the reactant gas for deposition and etching.

Preventing window clouding before it influences the optical properties of the window would seem to be the most viable solution to clouding, yet, heretofore has not yielded complete success. Preventing contaminants from reaching the viewport window often involves restricting the size of the passage(s) to the window. U.S. Pat. No. 6,762,849 to Rulkens entitled “Method for In-Situ Film Thickness Measurement and Its Use for In-Situ Control of Deposited Film Thickness,” discloses installing a fine metal mesh screen or bundle of small diameter tubes over the internal surface of the optical port entry for protecting the window. U.S. Pat. No. 4,407,709 to Enjouji, et al. entitled “Method and Apparatus for Forming Oxide Coating by Reactive Sputtering Technique,” discloses a window with slits for preventing clouding of the viewport window of a sputtering apparatus.

Another technique is to place a restrictor plate between the window and chamber that inhibits the passage of contaminants to the window. U.S. Pat. No. 6,170,431 to DeOrnellas, et al., entitled “Plasma Reactor with a Deposition Shield” discloses a reactor that includes a shield that prevents the deposition of materials along a line-of-sight path from a wafer toward and onto a window. The shield is comprised of a plurality of louvers or slats which are positioned at a skewed angle with respect to the wafer. However, this particular configuration would also inhibit line-of-sight optical measurements. Other restrictor devices include protruding shield designs, such as taught by Nakata, et al., in U.S. Pat. No. 6,576,559 to Nakata, et al., “Semiconductor Manufacturing Methods, Plasma Processing Methods and Plasma Processing Apparatuses.” There, the protruding shield has an angular cylindrical shape and is disposed between a laser source and window to prevent reaction generated material from intruding into the inner surface of the window as much as possible. The magnitude of gaps between shields is determined by properties of the laser beam and the scanning operation to be carried out by the laser galvano mirror. Brcka discloses, in U.S. Pat. No. 6,666,982 entitled “Protection of Dielectric Window in Inductively Coupled Plasma Generation,” protecting a dielectric window in an inductively coupled plasma reactor from depositions of coating or etched material with a slotted shield, however the slots permit some material to pass toward the window.

Other prior art window clouding restrictors include the notion of the mean free path of the molecules to be restricted. U.S. Pat. No. 5,145,493 to Nguyen, et al., entitled “Molecular Restricter,” discloses a restricter plate with cell dimensions based on mean free path of the molecules to be restricted. The molecular restricter comprises a plate with at least one elongated cell with parallel walls and open ends, wherein the cell has a width and length. Optimally, Nguyen, et al. report that the width should be less than one mean free path and the length of the cells should be greater that ten times the mean free path. Nguyen, et al. further assert that for an aspect ratio of 2/1 (length/width), the molecular transmission is about half of that where it is 1/1. At a ratio of 5/1, only about 9% is transmitted, on down to about 1% transmitted at a ratio of only about 12.5/1. Aqui, et al. also disclose, in U.S. Pat. No. 5,347,138 entitled “In Situ Real Time Particle Monitor for a Sputter Coater Chamber,” the use of mean free path to determine the dimensions of shield tubes open to a chamber, but for use on metal atoms dislodged from a target by a laser beam. Aqui, et al. state that the optimal width of the shield tubes is equivalent to less than one mean free path and their length are three times the mean free path or greater.

Still other attempts at preventing window clouding employ both a restrictor and the use of purge gas. U.S. Pat. No. 5,681,394 to Suzuki entitled “Photo-Excited Processing Apparatus and Method for Manufacturing a Semiconductor Device by Using the Same,” discloses a photo-excited processing apparatus that includes a reaction chamber filled with reaction gas, photo-excitation irradiating light source and a light transmissive window between the light source and chamber. A multi-holed transparent diffusion plate is arranged between the light transmissive window and a substrate in the chamber. However, the thickness of this diffusion plate is not discussed. Purge gas, either N₂ or O₂, enters between the transmissive window and the transparent diffusion plate. The combination of the diffusion plate and purge gas suppresses depositions to the surface of the light transmissive window. U.S. Pat. No. 6,110,291 to Haruta, et al. entitled “Thin Film Forming Apparatus Using Laser,” discloses introducing a clean purge gas, such as oxygen, through a pipe directly at the window (either the laser window or a sensor window) in order to clean the window. Additionally, Haruta, et al. teach the placement of an aperture and, alternatively, an elongated grid between the chamber and window so that the solid angle between the laser window and target is smaller in order to reduce the amount of dust that accumulates on the window.

### BRIEF SUMMARY OF THE INVENTION

A multichannel array structure is provided and a mechanism for establishing a gas flow within the multichannel array for preventing the flow of particulates that cause window clouding. A process chamber is provided for confining a process pressure within a process volume with a viewport window along the chamber for viewing at least a portion of the process volume. An ingress port is disposed in the process chamber, and to the process volume, for receiving a flow of process gas in the process volume and an egress port is disposed, and in the process chamber, to the process volume for extracting a flow of gas from the process volume. A multichannel array (MCA) is disposed between the viewport window and the process volume of the process chamber. The MCA has a plurality of channels, each of the channels having a diameter and a length. A window chamber is defined between the viewport window and MCA with a chamber window port for receiving gas into the chamber volume. A flow is formed at the window side of the channels in the MCA that prevents particulates from entering the window chamber and adhering to the window. The flow is established by increasing pressure in the window chamber via the chamber window port, wherein the window chamber pressure exceeds the process pressure, but not enough to substantially increase the flow rate of gas from the process volume. The flow rate is substantially lower than the flow of process gas into the process volume.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIGS. 1A and 1B are diagrams of portions of a multichannel array in accordance with an exemplary embodiment of the present;

FIG. 2 is a diagram of a process chamber with a barrier MCA for reducing window clouding in accordance with an exemplary embodiment of the present invention;

FIG. 3 is a diagram of a process chamber in which a non-process purge gas is used to create a back pressure between the MCA and viewport window in order to create a viscous flow for reducing window clouding in accordance with an exemplary embodiment of the present invention;

FIG. 4 depicts a diagram of a process chamber that uses a process gas to create a back pressure between the MCA and viewport window for preventing window clouding in accordance with another exemplary embodiment of the present invention;

FIG. 5 is a flowchart depicting a process for establishing viscous flow into an MCA while maintaining a low flow rate into the chamber from the MCA in accordance with an exemplary embodiment of the present invention;

FIG. 6 is a diagram of an MCA containing fluid for preventing window clouding in accordance with another exemplary embodiment of the present invention;

FIG. 7 depicts a diagram of an MCA containing fluid for preventing window clouding in which the fluid flow across the surface of the MCA in accordance with another exemplary embodiment of the present invention;

FIG. 8 depicts a diagram of an MCA with a window chamber containing fluid for preventing window clouding in accordance with another exemplary embodiment of the present invention;

FIG. 9 depicts a diagram of an MCA with a window chamber containing fluid for preventing window clouding, where the fluid flows through the window chamber in accordance with another exemplary embodiment of the present invention; and

FIG. 10 is a flowchart depicting a method for implementing an MCA to reduce window clouding while maintaining a low flow rate into the chamber from the MCA in accordance with an exemplary embodiment of the present invention.

Other features of the present invention will be apparent from the accompanying drawings and from the following detailed description.

### DETAILED DESCRIPTION OF THE INVENTION

### Element Reference Number Designations

Element Reference Number Designations

100: Multichannel Array (MCA)
102: Substrate
104: Channel
200: Multichannel Array (MCA)
202: Window
203: Optical Sensor
206: Window Chamber
210: Processing Chamber
212: Interior Of Processing Chamber
214: Wafer Support
216: Wafer
220: Plasma
232: Process Gas Inlet (Shower Head)
238: Processing Chamber Gas Outlet
300: Multichannel Array (MCA)
302: Window
303: Optical Sensor
306: Window Chamber
310: Processing Chamber
312: Interior Of Processing Chamber
314: Wafer Support
316: Wafer
320: Plasma
332: Process Gas Inlet (Shower Head)
334: Process Chamber Metering Valve
338: Processing Chamber Gas Outlet
342: Window Chamber Gas Inlet
344: Window Chamber Metering Valve
400: Multichannel Array (MCA)
402: Window
403: Optical Sensor
406: Window Chamber
410: Processing Chamber
412: Interior Of Processing Chamber
414: Wafer Support
416: Wafer
420: Plasma
432: Process Gas Inlet (Shower Head)
434: Processing Chamber Metering Valve
436: Process Gas Metering Valve
437: Process Gas Source
438: Processing Chamber Gas Outlet
442: Window Chamber Gas Inlet
444: Window Chamber Metering Valve
600: Multichannel Array (MCA)
602: Window
603: Optical Sensor
606: Window Chamber
608: High Viscosity Fluid
610: Processing Chamber
612: Interior Of Processing Chamber
700: Multichannel Array (MCA)
702: Window
703: Optical Sensor
706: Window Chamber
708: High Viscosity Fluid
710: Processing Chamber
712: Interior Of Processing Chamber
752: Fluid Inlet
754: Fluid Outlet
800: Multichannel Array (MCA)
802: Window
803: Optical Sensor
806: Window Chamber
807: Optional Fluid Window
808: Low Viscosity Fluid
810: Processing Chamber
812: Interior Of Processing Chamber
900: Multichannel Array (MCA)
902: Window
903: Optical Sensor
906: Window Chamber
908: High Viscosity Fluid
910: Processing Chamber
912: Interior Of Processing Chamber
952: Fluid Inlet
954: Fluid Outlet

A high-quality optical path is a necessity to perform most spectroscopic techniques, such as optical emission spectroscopy (OES) and reflectometry. Any obstruction that affects the intensity of the radiation degrades the accuracy and reliability of the technique. The obstruction may alter the intensity as a function of the wavelength. Typically, an optical sensor is positioned outside a process chamber and adjacent to a viewport window for obtaining optical measurements of a target within a process environment, (the process environment may be a process chamber, or along the up- or downstream piping associated with a processing chamber). Understanding the optical properties of these windows is critical for obtaining accurate measurements through them. As a viewport window becomes clouded, its optical properties change, sometimes in detrimental ways. Deposits must be cleaned from the viewport window, or the window replaced in order to maintain a high-quality optical path.

The problems associated with window clouding continues to plague the semiconductor industry. Prior art techniques for solving the window clouding problem involve either adjusting the intensity of the light transmitted through the window to compensate for window clouding (for an optical window), altering the optical measurement algorithms to compensate for clouding (for a view port window) or techniques for decreasing the frequency of window maintenance (cleaning or replacing the window and recalibrating the optical sensors at the viewport). Adjustment techniques are complicated and very difficult to implement as they vary with the specific implementation. Prior art techniques to reduce the frequency of window cleaning include disposing a restrictor plate between the window and the chamber in order to reduce the amount of contaminants that reach the window and, alternatively, to clean the exterior surface of the window with a flow of purge gas. Restrictor plates are not completely effective and merely lessen the amount of contaminants that reach the window. The cross-sectional area of the restrictor apertures may be decreased to further reduce the amount of contaminants that make their way to the window, but smaller apertures tend to clog with contaminates more often than larger apertures. However, unlike cleaning or replacing a viewport window, a restrictor plate can be replaced with an identical plate without having to recalibrate the optical sensors to the new plate. Of course, whenever the window does become clouded, the optical sensors should be recalibrated to the replacement window.

Cleaning the window with purge gas presumes that contaminates have, or will reach the window, but these contaminates can be detached with a current of gas. Firstly, this assumption may be incorrect; the contaminants that reach the window may bind to the surface of the window. In any case, directing a purge gas to the window suffers from shortcomings that makes this technique impractical for certain applications. For instance, utilizing the process gas for the purge stream eliminates incompatibility problems that may be associated with using non-process gases. However, often the process gas itself reacts with the window material which causes clouding. Ultimately, it may be necessary to change the window material in order to use the process gas as the purge gas. Using a non-process gas for the purge gas enables the operator to select the optimal window material for the optical measurement to be taken without concern for the window reacting with the purge gas. Another benefit in using a non-process gas as the purge gas is that the purge gas may be selected for its cleaning properties for the particular type of contaminant. The drawback with using non-process gases as the purge gas is twofold. First, the purge gas will not entirely prevent the process gas from reaching and reacting with the window, so in selecting the type of window material, the susceptibility of clouding by the process gas should be considered. More importantly, the non-process gas will often have a detrimental affect on the process. Therefore, the purge flow rate of the non-process gas should be kept to an absolute minimum, which may worsen the clouding rate.

Furthermore, each of these purge gas techniques require a significant amount of redesign to the area surrounding the window viewport. For instance, the purge gas should have a sufficient flow rate and oriented in a suitable direction to wipe the exterior of the window of any contaminates that adhere to the window. This requires the port (or ports) either be aimed at the window to force a stream of gas directly on the surface of the window or to design a cavity adjacent to the window that facilitates gas flow in lifting contaminates off the surface of the window and propelling them back into the process chamber.

None of the prior art techniques have had a substantial impact on the problem of window clouding. Many of these techniques are application-specific and require substantial modifications for each unique implementation. Most require substantial modifications be made to the system, usually at considerable expense, with only a marginal reduction in window clouding. What is needed is a method and system for reducing window clouding to the extent that the frequency of window maintenance be reduced to approximately that of cleaning the system.

Before discussing the proposed solution to window clouding, it is helpful to more fully understand the causes of window clouding. Understanding the causes for window clouding will facilitate determining the best method to prevent or reduce the clouding. It is necessary to consider the creation (origin) mechanism, the transport to the window surface, and the action on the window surface. These will be discussed in reference to a typical processing chamber that is well known in the semiconductor industry, but this is merely exemplary for the purpose of describing certain aspects of the present invention. The present invention is equally useful in upstream or downstream piping for making optical measurements.

In many environments, the viewport window is not in the line of sight of the wafer. Also, the mean free path of any material in the chamber gas is much smaller than the distance to the window. So, little sputtered material from the wafer usually goes directly to the window.

The origin of particles may be from reaction products on the chamber wall that flake off. Alternatively, these particles may be formed from the plasma chemistry and might coalesce in the plasma, or be a byproduct of some other high energy reaction, such as from a laser.

The particles in the chamber may diffuse to the window surface. The equation for Brownian motion is described below.

$$\overline{{x}^{2}} = \frac{kT}{3 π \cdot η \cdot a} \cdot t \qquad ( 1 )$$

where x̅²̅ is the mean displacement of the particles,

a is the radius of particle,

t is the time,

T is the temperature of the media, and

η is the viscosity.

This indicates that migration for particles one micron in diameter is extremely slow, 6×10⁻¹⁰ cm/sec, for typical conditions. Particulates may migrate to the window by thereto-mechanical effects of turbulence, e.g., movement from turbulence when the chamber is back-filled, etc. Therefore, care should be taken when back-filling a chamber. Additionally, particulates may move toward the window as a result of thermal gradients, that is, they travel to the window by thermomolecular flow (or thermal transpiration) caused by a difference in temperature between the wafer and the window or thermal turbulence from the high temperature of the plasma, etc. Once at the window, the particulates may adhere to the window as a coating, resulting from either electrostatic attraction or chemisorption.

Reactive gases from the plasma and reaction products from the wafer may be transported to the window surface by diffusion, turbulence, thermal gradients, etc. At the window surface, these gases may change the optical transmission of the window in a number of ways. If reactive gases reach the window surface, they may bond to the surface by chemisorption, electrostatic attraction, etc. and form a film. If some material is being deposited, then the exact composition of the deposited material should be determined. Alternatively, or additionally, the window surface may be etched by the reactive gases. If the window is fused silica or glass, substituting sapphire as a window material may be advantageous as sapphire is more resistant to etching. Still further, it is possible that a change in the bulk composition of the window is caused by material dissolving into the window. For example, an alkali (Na, Cs, etc.) may dissolve in the quartz to produce a brown color. Radiation from the plasma may cause the optical properties of the window to change. Therefore, some of the gas components may photolyze in the window area and coat the window. Also, some of the constituent gases may chemisorb to the window and be transformed by photocatalysis to a material that coats the window.

Heating the window may reduce or eliminate coating to the window. This may reduce the sticking coefficient so that material does not stick initially to the window. Alternatively, it may help to evaporate or decompose material that is already deposited. It may be necessary to heat the window to as much as 200° C. to prevent the window from clouding. For a continuous mechanism, this may be done by adding heating elements to the window. Other methods might be heat lamps or high power lasers. For a pulsed mechanism, ablation of the absorbed material can be done with flash lamps or pulsed lasers.

Plates with channels through them are known in the prior art. These plates have been put to many uses such as electron multipliers, atomic beam collimators, neutron collimators, windows, etc. These prior art plates have been made of various metals, insulators and glasses. When used for preventing window clouding, the aperture size is sometimes decreased in order to reduce the amount of contaminants that reach the window, alternatively they are sometimes oriented askew of the optical path to the window to inhibit the straight-line path to the window for contaminants. Some prior art references have suggested a relation between the mean free path (MFP) and the aperture dimensions through the plate.

In accordance with one exemplary embodiment of the present invention, the dimensions of the channels in the MCA may be predicated on the mean free path (MFP) of the molecules that cloud the window. By using MFP as a metric, the MCA can be designed that will act as a barrier to slow the transport to the window and a getter that collects material in the channels.

The MFP, L_{α}, is approximately given by,

$${L}_{α} = 8.589 \cdot \frac{η}{{P}_{mm}} \sqrt{\frac{T}{M}} \qquad ( 2 )$$

where η is the viscosity,

Pₘₘ is the pressure,

T is the temperature, and

M is the mass of the particle.

The L_{α} MFP for Argon (Ar) at 150 milliTorr is L_{α}=0.4 mm.

For optimal barrier results, the length L of the channels should be much greater than the MFP L_{α} of the gas, or particulate, that will cloud the window (L_{α}<<L). This will slow the material that passes through the channel along the axis. Additionally, the channel diameter, d, should be less that the MFP (L_{α}≧d). This will enhance sticking to the wall of the MCA and reduce diffusion. However, the channel diameter of the channels should be large enough to avoid frequent blockage.

Even though the barrier MCA will reduce the rate of clouding, ultimately material will pass through the channels of the MCA and begin to cloud the window. This clouding can be acceptable if the time between cleaning cycles is much less than the time that it takes to cloud the window.

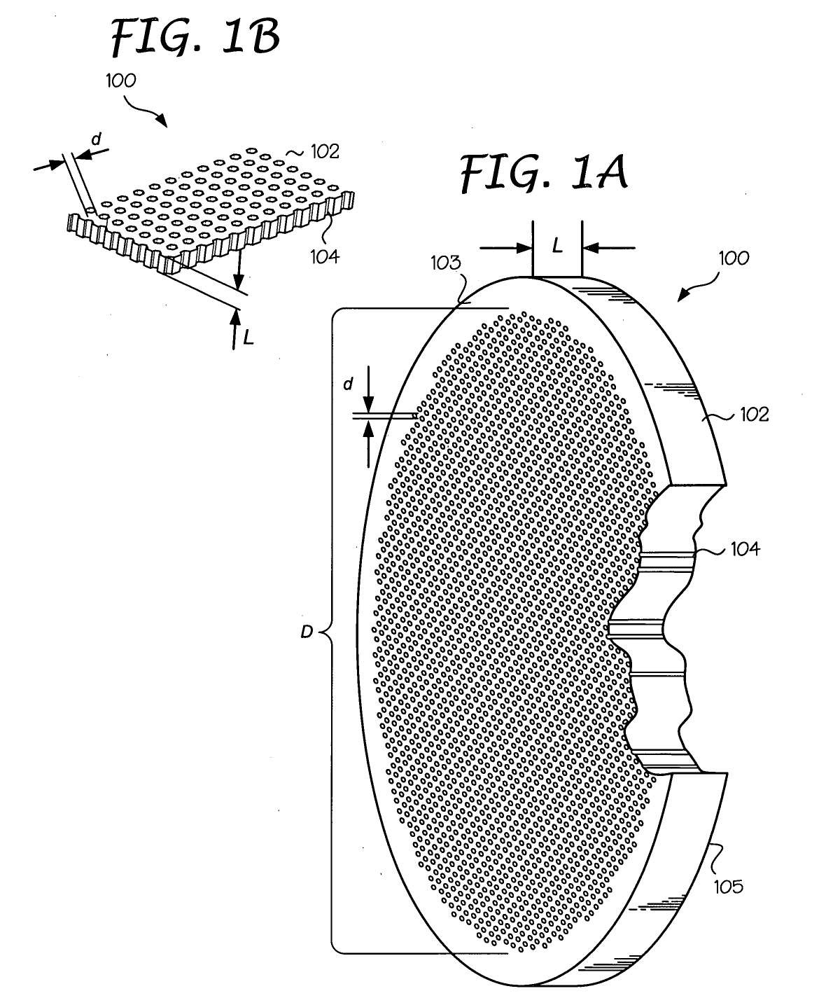

FIGS. 1A and 1B are diagrams of portions of a barrier multichannel array (MCA) as will be described below with respect to the present invention. MCA 100 is referred to as a barrier MCA because the structure of the MCA itself inhibits window clouding by acting as a barrier to particulates that may cloud the window. MCA 100 comprises body 102 with first and second surfaces (103 and 105) and a plurality of channels 104 traversing body 102 from first surface 103 to second surface 105. Body 102 of MCA 100 in FIG. 1A is depicted as having a generally circular cross-sectional shape, however this is merely exemplary as the shape of body 102 is predicated on the installation implementation to the processing chamber. Typically, one surface of MCA 100 is the interior or window-side surface 103, and the other surface is the exterior or chamber-side surface 105. The designation of interior and exterior is in reference to a window chamber that will be described below. Because one surface, chamber-side surface 105 is exposed to the interior of the processing chamber, the material selected for body 102 should be non-reactive with the internal processes in the chamber. Furthermore, if a non-opaque material is selected for body 102 (i.e., optically transmissive with respect to the optical sensors employed for the measurements), the chamber-side surface 105 may become optically clouded in a similar manner as the window and affect the optical measurements. Therefore, optimally, body 102 should be opaque for the optical wavelengths being measured or coated with a non-reactive and opaque coating in order to maintain uniform transmission through the MCA as outer surface 105 becomes cloudy.

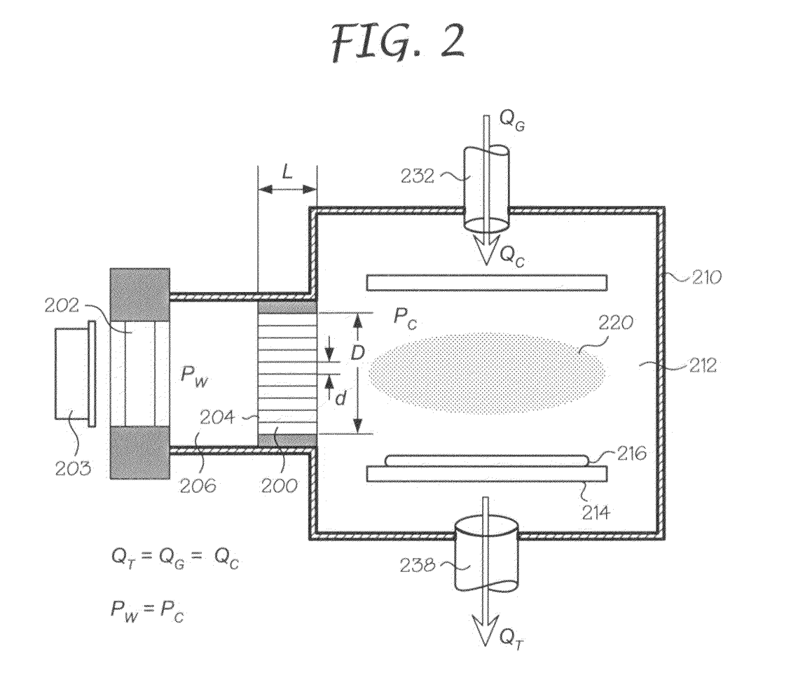

With continuing reference to FIGS. 1A and 1B, MCA 100 is shown installed on chamber 210 as MCA 200 in FIG. 2. Notice that channels 204 traverse body 102 and are in the optical path between optical sensor 203, located adjacent to and outside the viewport window 202, and the target (here the target is depicted as plasma 220). The axes of channels 204 are substantially parallel to the optical path. Thus, each of channels 204 is parallel to every other channel through body 102. The exact cross-sectional shape of channels 204 is not of particular importance to the present invention, although as a practical matter some cross-sectional shapes are much more easily fabricated than others. What is of concern in preventing particulates from reaching the window is the dimensions of the channels.

As mentioned above, since the MFP is the distance between collisions, the channel diameter, d, for barrier MCA 200 should be one MCA or less. For a barrier MCA, the diameter d is understood as the minimum cross-sectional distance of the channel opening. Thus, for circular channels, it is the diameter at any point across the center point of the circle, but for polygonal cross-sectional shapes, that placement for d varies with the shape (notice in FIG. 1B, d is taken across parallel sides, however for a pentagon, d is taken from any vertex to the midpoint of an opposite side). It is expected that the channel diameter d will remain constant across the channel length L, but it should be understood that there may be advantages for varying d with L from window-side surface 103 toward chamber-side surface 105. For instance, a conical channel (small end at window-side surface 103) may direct more light to the optical sensor. To prevent molecules from traversing the length of a channel along its axis, the channel length, L, should be substantially larger than the MFP of the contaminant. Length dimensions of between three and twelve MFPs have been discussed in the prior art.

The material of MCA 200 should have a large sticking coefficient for the materials that are diffusing to the window. This may be accomplished by, for example, using the same material for MCA 200 as for window 202, so the sticking coefficient would be the same. Cooling MCA 200 may also increase the sticking coefficient.

MCA 200 will have a quantity of N channels 204 across its body. The quantity, N, and the placement of channels 204 will affect the character of the optical measurement by optical sensor 203. Therefore, the N channels 204 should be distributed uniformly over at least the portion of MCA 200 that is in the optical path of optical sensor 203 and, if possible, across the entire viewport of optical sensor 203. Because barrier MCAs are not totally effective in preventing contaminants from reaching the window, the amount of material that gets by the MCA is proportional to the number of channels, N, therefore N should be kept as low as possible without sacrificing optical quality.

With further reference to FIG. 2, a diagram of an implementation of a barrier MCA is shown in accordance with an exemplary embodiment of the present invention. There, processing chamber 210 is shown with interior 212 in which plasma 220 is ignited from, for instance, as reaction on wafer 216 which rests on wafer table 214. Process gas enters interior 212 through ingress port, or process gas inlet 232 (typically a shower head) and exits interior 212 through egress port, processing chamber gas outlet 238 (and on to the vacuum pump). Flow into volume 212 of chamber 210 from process gas inlet 232 is shown diagrammatically as an arrow and is represented as Q_{W}. and flow to the vacuum pump (not shown) is also shown diagrammatically as an arrow but is represented as Q_{T}. Typically, window 202 is disposed along one surface of the interior of chamber 210, either side, top or bottom surface, in a position and orientation such that optical sensor 203 will have a direct line of sight to the target (here the target is plasma 220). In implementations where line-of-sight measurements are unnecessary, the position and orientation of window 202 may be different. In some applications, multiple windows will be installed at various locations along the interior surface of chamber 212.

In any case, MCA 200 is disposed between interior 212 of chamber 210 and window 202 such that a volume is created between the window and MCA, represented as window chamber 206. It should be understood that the exact shape, dimensions, and even the existence of window chamber 206 is relatively unimportant for practicing the present barrier MCA of the present invention. There may, however, be only a slight gap between the inner openings of channels 204 and window 202. The pressure within chamber 210 is represented as chamber pressure P_{C} and the pressure within window chamber 206 is represented as window chamber pressure P_{W}. In general, chamber pressure P_{C} is determined by the process and P_{W} is substantially equivalent to P_{C}.

As mentioned above, barrier MCA 200 can be made of any non-reactive material including, glass, sapphire, and other insulators, stainless steel, aluminum, exotic metals and other conductors and semiconductors. The outer surface (chamber side) of MCAs made from materials that are transparent at the wavelength to be measured by optical sensor 203 may be coated with a non-transmissive coating in order to maintain uniform transmission through the MCA as the outer surface becomes cloudy.

Next, it is desired to approximate values for the amount of material that reaches the window. But primarily, this is useful for insight into how the various parameters affect the flow rate. The diffusion may occur by:

Molecular—mean free path is much larger than the channel diameter (MFP>>d)

Viscous—mean free path is much smaller than the channel diameter (MFP<<d)

For molecular diffusion through the channel, the conductance is,

$${F}_{a} = \frac{2}{3} π \frac{{r}^{3}}{L} {v}_{m} \qquad ( 3 )$$

where, r=d/2 is the radius of the channel,

L is the length of the channel, and

vₘ is the mean molecular speed.

The flow rate Qₐ through a single channel is,

Qₐ=Fₐ(P_{c}−P_{w}) (4)

where P_{C} is the chamber partial pressure, and

P_{W} is the window partial pressure.

The total flow rate Q_{A} through the multichannel array is,

Q_{A}=N·Qₐ (5)

where N are the number of channels in the array.

In accordance with still another exemplary embodiment of the present invention, a novel multichannel array approach for preventing window clouding is presented by creating a gas flow through the MCA that acts as a barrier to particulates, atoms, molecules, ions, etc that would cause the window to cloud. The flow is in the direction of the process chamber from the window chamber. The flow could range from molecular diffusion, as described by equations 3, 4 and 5, to viscous flow. The effectiveness, for preventing window clouding, would increase from the molecular diffusion regime to the viscous flow regime. For viscous flow, in principle, no material will pass through the multichannel array to cloud the window. The viscous flow in the channels act as a barrier and sweeps impurities back into the chamber. The viscous flow need not extend the entire length of the channel. The aim is to establish a flow rate, Q_{A}, at the MCA, that acts as a barrier to contaminants, while simultaneously maintaining the process flow rate, Q_{C}, substantially higher than the viscous flow rate Q_{A} for the MCA. (Q_{C}>>Q_{A}). Consequently, the amount of gas flowing into the process chamber through MCA, Q_{W}, will not adversely affect the process.

The viscous flow rate Qₐ, through a channel is given by the Poiseuille equation,

$${Q}_{a} = \frac{π \cdot {r}^{4}}{8 \cdot η \cdot L} {P}_{a} \cdot ( {P}_{W} - {P}_{C} ) \qquad ( 6 )$$

where r=d/2 is the radius of the channel,

L is the length of the channel,

η is the viscosity,

P_{C} is the chamber partial pressure,

P_{W} is the window partial pressure, and

Pₐ is the mean pressure ((PW+PW)/2).

Therefore, the total flow viscous flow rate, Q_{A}, through the multichannel array is,

Q_{A}=N·Qₐ (7)

Initially, the viscous flow rate, Q_{A}, across an MCA having particular dimensions is determined for a process (viscosity η and chamber partial pressure P_{C}) at a given window pressure P_{W} from Equations 6 and 7. Viscous flow rate Q_{A} is then compared to the flow rate, Q_{C}, for the process. If Q_{C} is not substantially greater than Q_{A}, the back pressure P_{C} can be increased or, alternatively the dimensions of the MCA can be altered (decreasing channel diameter d or increasing channel length L or both). P_{C}, d, N and L can be adjusted until Q_{A} is lowered to an acceptable flow rate.

In accordance with one exemplary embodiment, an MCA is designed with generic dimensions in which viscous flow rate Q_{A} can be established for a wide variety of processes (viscosities η and the associated chamber partial pressures P_{C}) such that Q_{C}>>Q_{W}, merely by adjusting the back pressure P_{W}. Alternatively, the generic MCA dimensions would allow for a viscous flow rate across a wide range of back pressure values. For example, by selecting representative dimensions for the MCA, the viscous flow rate Q_{A} can be determined for a process (pressure viscosity η and the associated chamber partial pressure P_{C}). For instance, L=2.0 cm, d=0.1 cm, and D=1.0 cm (diameter D is the effective diameter for N channels of diameter d). The chamber pressure is set at the working chamber pressure for the process, e.g., P_{C}=150 microns. For a back pressure of P_{W}=1.0 Torr, the viscous flow through the MCA is Q_{A}=0.41 sccm. For P_{W}=10 Torr, the flow through the MCA is Q_{A}=4.41 sccm. Both these flow rates are small compared to a typical working flow rate of Ar in a chamber, Q_{C}(Ar)˜500 sccm.

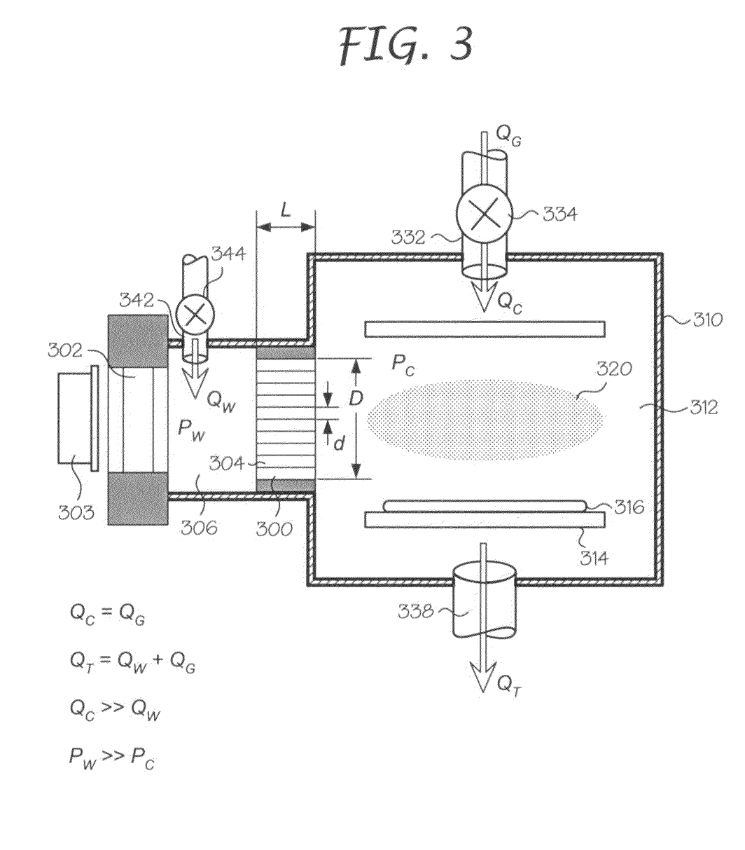

With reference now to FIG. 3, a diagram of a process chamber in which a non-process purge gas is used to create a back pressure between the MCA and viewport window in order to create a gas flow for reducing window clouding in accordance with an exemplary embodiment of the present invention. Here, processing chamber 310 is shown with interior 312 in which a plasma 320 as discussed above with regard to FIG. 2. Process gas traverse valve 334 at flow rate Q_{G} and enters interior 312 through ingress port 332 at a flow rate of Q_{C} and through egress port 338 at flow rate Q_{T}. The chamber pressure is represented as P_{C}.

MCA 300 is disposed between interior 312 of chamber 310 and window 302 forming window chamber 306. The specific dimensions of window chamber 306 are unimportant because the existence of the window chamber does not prevent clouding. It merely serves as a manifold to distribute P_{W} across all of the N channels 304 of MCA 300. Furthermore, the gas flow dynamics within window chamber 306 do not assist in cloud prevention because the viscous flow at the window side of channels 304 acts as a complete barrier to materials that might cloud the window. Clouding is prevented by the viscous flow at the widow side of channels 304 and not because of the existence or structure of window chamber 306. Particulates are stopped by the viscous flow barrier with MCA 300, if not before, and swept out of the MCA by the window flow Q_{W}.

Window chamber gas inlet 342 permits purge gas to enter window chamber 306 as metered by window chamber metering valve 344. With regard to the exemplary embodiment, the purge gas comprises a non-process gas, such as an inert gas, e.g., n₂, but in accordance with other embodiments, may instead be process gas. The pressure (or back pressure) within window chamber 306 is represented as window chamber pressure P_{W}. Because gas enters the interior of chamber 310 from both ingress port 332 and across MCA 300 from window chamber gas inlet 342, Q_{T}=Q_{C}+Q_{W}. The purpose of metering valve 344 is to independently adjust back pressure P_{W} of the purge gas in window chamber 306 and resulting window flow rate, Q_{W}.

A gas barrier that prevents window clouding may be realized by adjusting window back pressure P_{W} to create a viscous flow (Q_{A}) in the window side of channels 304. The gas flow entering chamber interior 312 from MCA 300 (Q_{W}) is kept low in comparison to the gas entering the chamber from the inlet (Q_{C}), Q_{C}>>Q_{W}, by adjusting window back pressure P_{W} just enough to reach viscous flow in the channels, P_{W}>>P_{C}, but not so high as to flood chamber 310 with purge gas (i.e., Q_{C}>>Q_{W}). An acceptable value for the window flow rate Q_{W} can be determined from Equations 6 and 7 and that window flow rate Q_{W} should be compared to the chamber flow rate Q_{C}. If window flow rate Q_{W} is too high, P_{C} can be reduced or the channel dimensions for MCA 300 can be altered.

It should be appreciated that the dimensions of channels 304 are not strictly related to the MFP of the molecules causing clouding as in the barrier MCA embodiments described above. In fact, channel diameter d may be significantly larger than MFP and/or channel length L may be significantly shorted than 3×-12×MFP while still preventing window clouding. This is so because a viscous flow can be established by increasing P_{W} even though the channel dimensions would not support a barrier MCA. However, high back pressure values tend to increase the window flow rate Q_{W} to a point that may be detrimental to the chamber process.

As mentioned elsewhere above, with some chamber processes the infusion of large quantities of a non-process gas may have a detrimental affect on the process. Therefore, the flow rate of any non-process gas into chamber 310 should be kept low. As described above, the formation of the viscous flow at the window side of channels 304 prevents window clouding while managing P_{W} simultaneously keeps the flow rate, Q_{W}, of purge gas into the process chamber low. Thus, the viscous flow barrier technique provides a useful mechanism for using non-process purge gases for preventing window clouding without detrimentally affecting the process in the chamber.

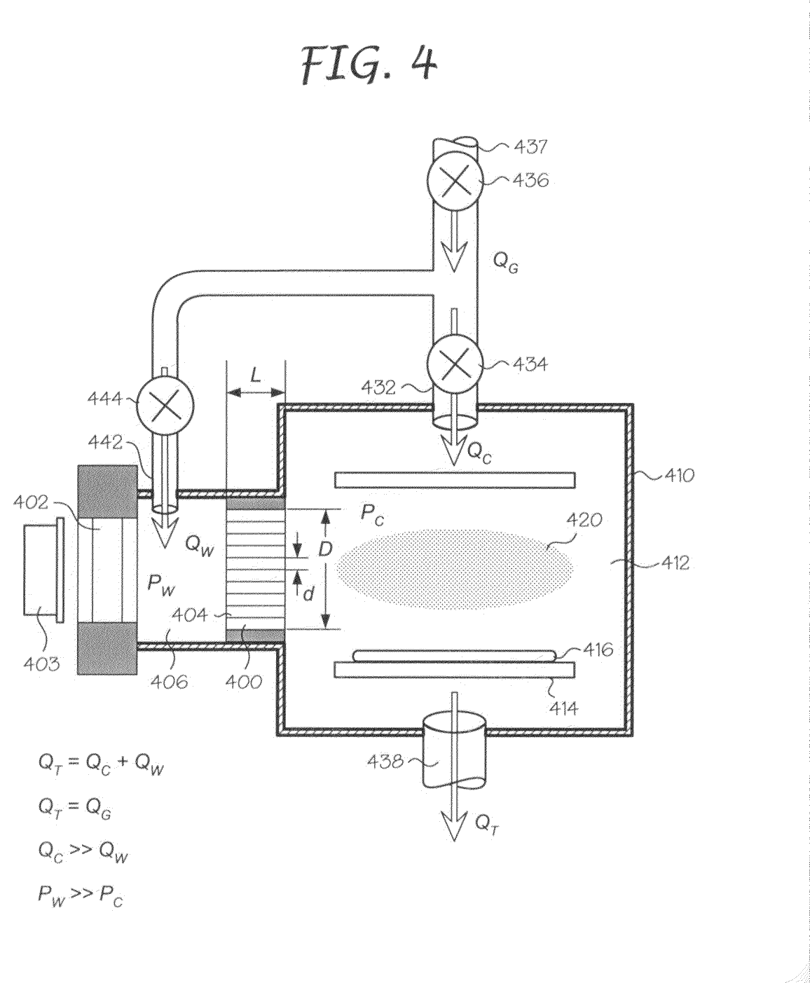

Process gas may also be used as window protection with the presently described viscous flow barrier technique with a multichannel array. FIG. 4 depicts a diagram of a process chamber that uses a process gas to create a back pressure between the MCA and viewport window for preventing window clouding in accordance with another exemplary embodiment of the present invention. Here, the configuration is essentially identical to that described above with regard to FIG. 3, with the exception of the process gas manifold connecting process gas inlet 432 with window gas inlet 442 and allowing process gas to flow into window chamber 406. There, the process gas is received at valve 436 as a flow rate of Q_{G}, which is diverted to chamber metering valve 434 and window metering valve 444. The purpose of the metering valves is to enable the pressure and flow rate window chamber 406 to be adjusted independently from the pressure and flow rate of chamber 410. The pressure within chamber 410 is represented as chamber pressure P_{C} and the pressure within window chamber 406 is represented as window chamber pressure P_{W}. Because gas enters the interior of chamber 410 from both ingress port 432 and across MCA 400 from window chamber gas inlet 442, Q_{T}=Q_{C}+Q_{W}. However, the flow rate to the manifold (Q_{G}) is used to feed both window chamber 406 and chamber 410, so Q_{G}=Q_{T}. As discussed above, gas entering the chamber from the MCA (Q_{W}) is kept low in comparison to the gas entering the chamber from the inlet (Q_{C}), Q_{C}>>Q_{W}, by adjusting window back pressure P_{W} just enough to reach a viscous flow in the channels, P_{W}>>P_{C}. An acceptable value for the window flow rate Q_{W} can be determined from the operating flow rate Q_{C} for the process in the chamber, and a value for window back pressure P_{W} is determined such that a predetermined threshold value for flow rate Q_{W} is not exceeded.

Alternately, process gas for purging window chamber 406 may be secured independently from inlet 437. In that case, the manifold discussed above may be omitted and the system will look and operate identically to that described above with regard to FIG. 3, albeit with process gas rather than non-process gas.

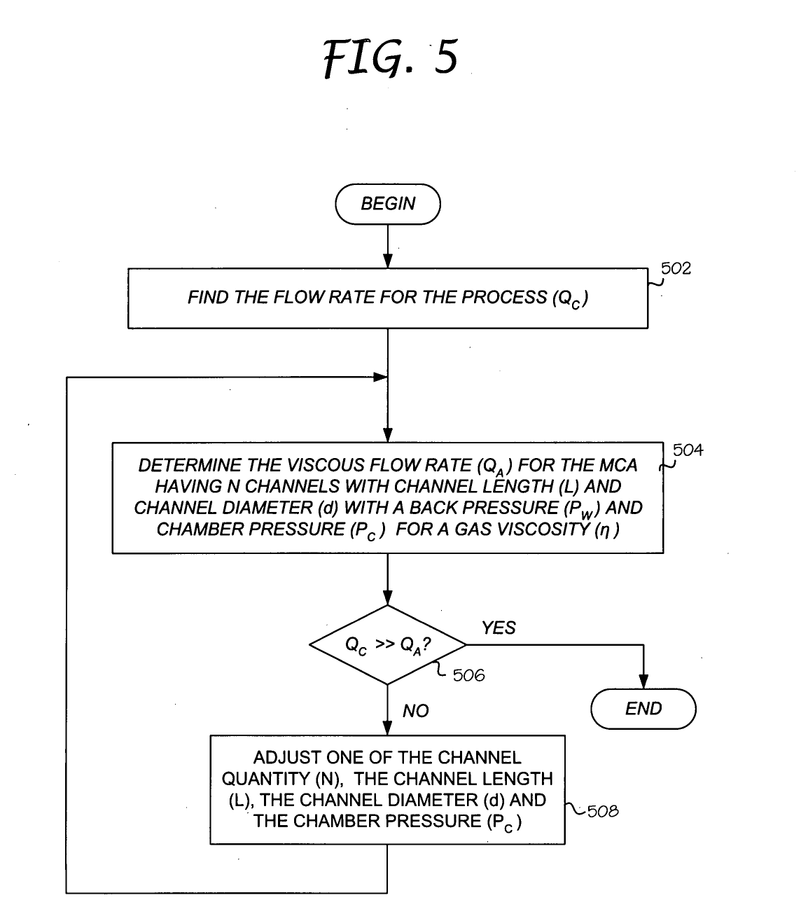

By understanding that the viscous flow rate at the window side of an MCA will effectively block all clouding materials and the flow across the MCA sweep all particulates from the MCA channels into the chamber, a generic MCA can be constructed that will enable viscous flow for a wide variety of process gases, particulates and chamber pressures, while maintaining a relatively low window flow rate (Q_{W}) into the process chamber (thus maintaining Q_{C}>>Q_{W}). From Equations 6 and 7 above, it is then apparent that the operator need merely adjust the back pressure P_{W} to achieve Q_{A} for the particular MCA. FIG. 5 is a flowchart depicting a process for establishing viscous flow into an MCA while maintaining a low flow rate into the chamber from the MCA in accordance with an exemplary embodiment of the present invention. It is expected that the chamber pressure, P_{C}, and the flow rate into the chamber, Q_{C}, will be constant and nonadjustable. Initially, the process flow rate into the chamber (Q_{C}) is found (step 502). Next, the viscous flow rate (Q_{A}) is calculated for the window side of an MCA with a quantity of channels (N), each having a chamber length (L), chamber diameter d, having a back pressure P_{W} and chamber pressure P_{C} for a gas viscosity (η) (step 504). Next, Q_{A} is compared to Q_{C} (step 506). If Q_{C}>>Q_{A}, then process ends as Q_{A} is established as the back pressure Q_{W} necessary for establishing viscous flow without a substantial increase in the chamber flow. If Q_{A} exceeds a maximum threshold amount, one or all of back pressure P_{W}, channel quantity N, chamber length L and chamber diameter d is adjusted (step 508) and the process reverts to step 504 and continues to iterate through steps 504 through 508 until Q_{A} is below the maximum threshold amount and Q_{C}>>Q_{A}. The process then ends as Q_{A} is established as the back pressure Q_{W} necessary for establishing viscous flow without a substantial increase in the chamber flow.

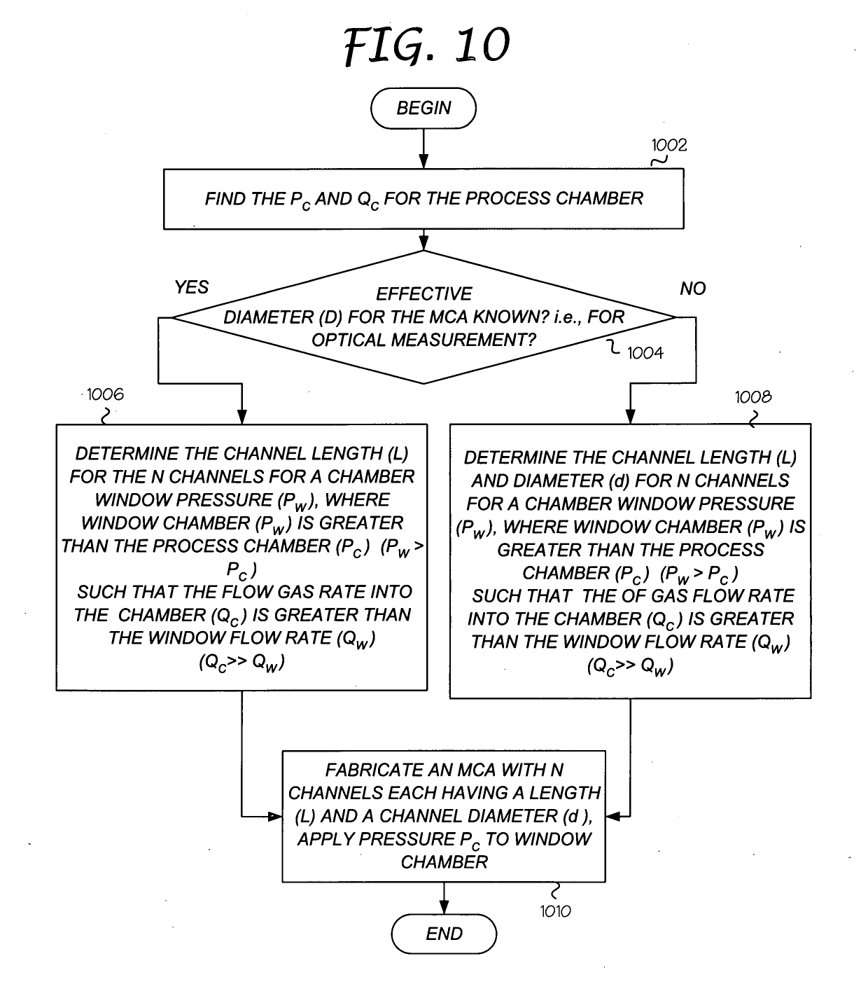

As mentioned above, while establishing a viscous flow at the widow side of the MCA may be desirable, window clouding may be reduced or prevented by creating a pressure differential across the channels of the MCA. FIG. 10 is a flowchart depicting a method for implementing an MCA to reduce window clouding while maintaining a low flow rate into the chamber from the MCA in accordance with an exemplary embodiment of the present invention. It is expected that the chamber pressure (P_{C}) and the flow rate into the chamber (Q_{C}) will be constant and nonadjustable. Initially, the process flow rate into the chamber (Q_{C}) and the chamber pressure (P_{C}) are found (step 1002). For some applications of the present invention, the implementation of the MCA may be further constrained by optical measurement to be made through it. In those situations, it is expected that the MCA should have an effective diameter (D) and so the channel diameter (d) and quantity of channels N will be determined for the effective diameter D. Hence, a decision is made as to whether there is a requirement of a specific effective diameter D for the optical measurements (step 1004). If the effective diameter D is known, then the channel length (L) for the N channels is determined for a chamber window pressure (P_{W}) (or the backpressure at the MCA), where the window chamber pressure (P_{W}) is greater than the process chamber pressure (P_{C}) (P_{W}>P_{C}) such that the process flow rate (Q_{C}) is greater than the flow rate into the chamber through the MCA (Q_{W}) (Q_{C}>>Q_{W}) (step 1006). With the channel diameter (d) and channel length (L) for the N channels, an MCA can be fabricated for reducing window clouding with a back pressure of P_{W} applied to the window side of the channels (step 1010).

If, on the other hand, If the effective diameter D is not known, then all of the dimensions of the MCA may be manipulated for creating a backpressure (P_{W}) to reduce window clouding. Thus, the channel length (L), channel diameter (d) and the quantity of channel N may be determined for a chamber window pressure (P_{W}). Recall that window chamber (P_{W}) is greater than the process chamber (P_{C}) (P_{W}>P_{C}) and the flow rate into the chamber through the MCA (Q_{W}) is much lower than the process flow rate (Q_{C}) (Q_{C}>>Q_{W}) (step 1008). Here again, with the channel length (L) and channel diameter (d) for the N channels, an MCA can be fabricated for reducing window clouding with a back pressure of P_{W} applied to the window side of the channels (step 1010).

Multichannel arrays have been used with fluids for various optical devices. In this context, the behavior of the fluid is determined by the relative strength of the attraction of the surface of the solid to the cohesive intermolecular forces inside the liquid.

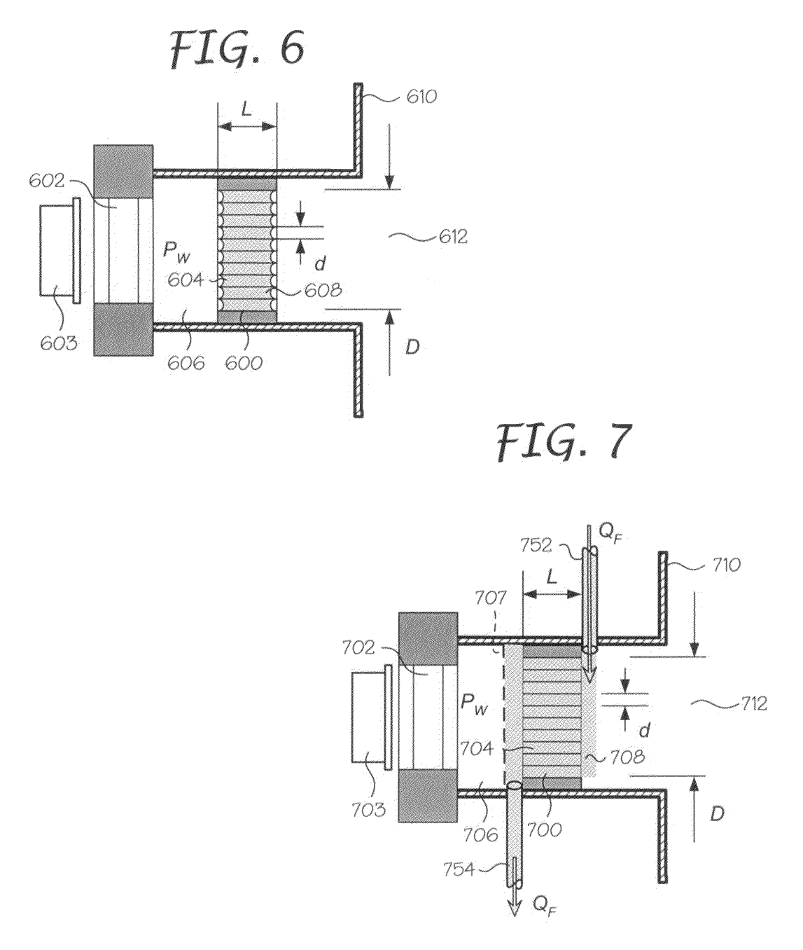

In accordance with one exemplary embodiment of the present invention, an MCA contains a fluid, such as high-vacuum pump oil. The fluid has a relatively low liquid-to-solid surface tension and so wets the MCA. The liquid surface has a relatively greater attraction to the MCA surface than to the bulk liquid. The contact angle is less than 90 degrees and has a concave meniscus. The contact angle is the angle of contact of the surface of the liquid with the wall of the channel. FIG. 6 is a diagram of an MCA containing fluid for preventing window clouding in accordance with another exemplary embodiment of the present invention. Here, structure 610 contains volume 612 in which a target (not shown) is optically monitored. Structure 610 may be a process chamber or up-or down stream pipe with a target. Window 602 is disposed in structure 610 and optical sensor 603 is located adjacent to window 602 on the exterior of structure 610. MCA 600 is disposed between window 602 and volume 612. Each of MCA channels 604 contains fluid 608. Fluid 608 prevents particulates from traversing MCA 600 and thereby prevents the clouding of window 602.

Note that the configuration in FIG. 6 can withstand a large pressure differential between P_{W} and P_{C} since the MCA channel has a small diameter. The relation between the pressures is given by Laplace's equation,

$${P}_{1} - {P}_{2} = α ( \frac{1}{{R}_{1}} - \frac{1}{{R}_{2}} ) \qquad ( 8 )$$

where a is the surface tension,

P₁ and P₂ are the pressures at the interlaces, and

R₁ and R₂ are the radii of curvature for the interfaces.

FIG. 7 depicts a diagram of an MCA containing fluid for preventing window clouding in which the fluid flow across the surface of the MCA in accordance with another exemplary embodiment of the present invention. Here, the elements are identical to those described above with the exception of the inclusion of fluid inlet 752 and fluid outlet 754. With regard to this embodiment, fluid 708 is caused to flow against MCA 700, is drawn into channels 704 by capillary action. Fluid 708 is removed from channels 704 by a partial vacuum at fluid outlet 754 and is filtered and recycled back to fluid inlet 752 (not shown).

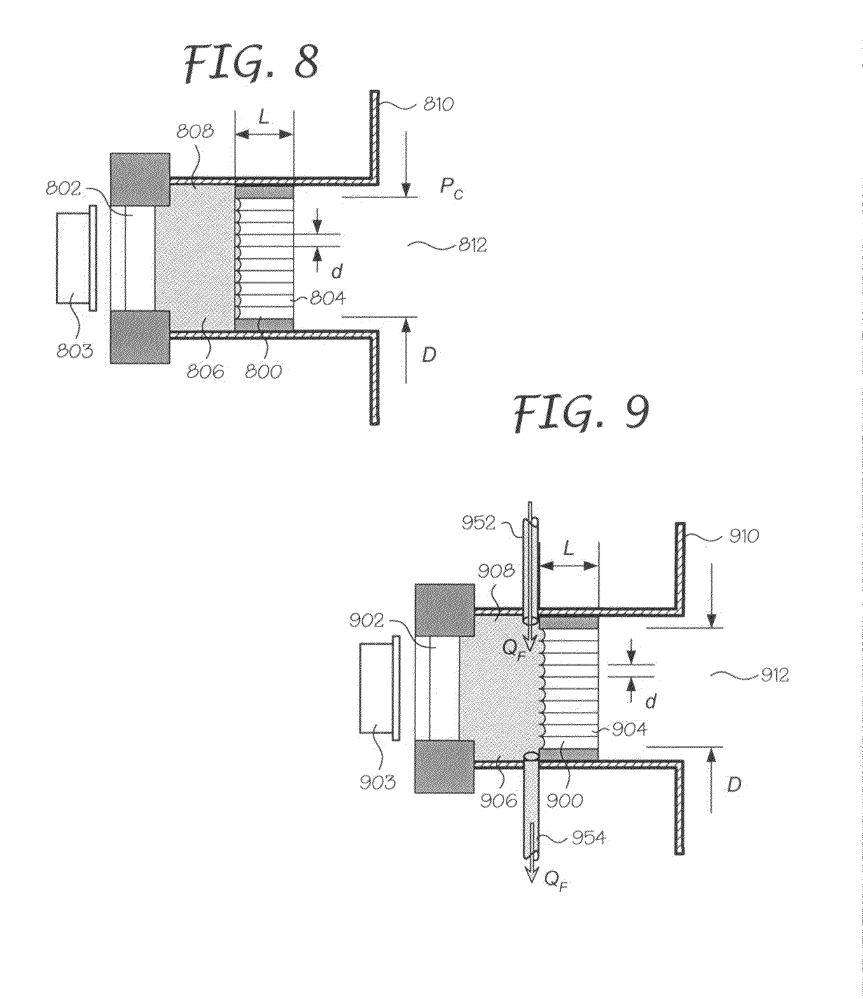

FIG. 8 depicts a diagram of an MCA with a window chamber containing fluid for preventing window clouding in accordance with another exemplary embodiment of the present invention. Here, the elements are identical to those described above, however fluid 808 is contained in window chamber 806. Fluid 808 has a relatively high liquid-to-solid surface tension and so does not wet channels 804 of MCA 800. The liquid surface has a relatively greater attraction to the bulk of the liquid than to the MCA surface. The contact angle is greater than 90 degrees and has a convex meniscus. The contact angle is the angle of contact of the surface of the liquid with the wall of channel 804.

FIG. 9 depicts a diagram of an MCA with a window chamber containing fluid for preventing window clouding, where the fluid flows through the window chamber in accordance with another exemplary embodiment of the present invention. Here, the elements are identical to those described above in FIG. 8, except that fluid 908 is circulated through window chamber 906 via fluid inlet 952 and fluid outlet 954. Fluid 908 flows through window chamber 906 against MCA 900 and is removed to be filtered and recycled at fluid outlet 954.

The exemplary embodiments described below were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention is not intended to be limited to the embodiment shown, but is to be accorded the widest scope consistent with the principles and features described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A device for reducing window clouding in a viewport window of a process chamber, comprising:
a process chamber comprising:
a plurality of walls which at least partially enclose a process volume,
wherein a process pressure exists within the process volume;
at least one ingress port traversing the process chamber to the process volume; and
at least one egress port traversing the process chamber to the process volume;
a material within the process volume;
a viewport window disposed along one of the walls of the process chamber;
a window chamber defined by the viewport window, a portion of the one of the walls of the process chamber and a multichannel array;
a window chamber ingress port traversing the one of the walls of the process chamber to the window chamber; and
the multichannel array comprising:
a body having an interior surface and an exterior surface for pneumatically isolating a window chamber pressure within the window chamber from the confinement pressure; and
a predetermined quantity of channels, each of said predetermined quantity of channels having an interior end and an exterior end, a cross-sectional shape with a channel diameter and a channel length between the interior and exterior ends, at least one of said channel diameter, said channel length and said predetermined quantity of channels being related to establishing a flow rate across the predetermined quantity of channels with a pressure differential across the predetermined quantity of channels.

2. The device recited in claim 1 further comprises:
a substrate, wherein the material is one of a process gas or a by-product of the substrate.

3. The device recited in claim 2, wherein the process pressure is related to at least one of an ingress flow rate and an ingress pressure of process gas entering the process chamber at the ingress port and the window chamber pressure is related to at least one of a window chamber ingress port flow rate and a window chamber ingress pressure from window chamber gas entering the window chamber at the window chamber ingress port.

4. The device recited in claim 3, wherein the window chamber pressure is greater than the process pressure.

5. The device recited in claim 4, wherein the window chamber ingress pressure is greater than the ingress pressure.

6. The device recited in claim 5, wherein the window chamber ingress port pressure is less than the ingress flow rate.

7. The device recited in claim 5 further comprises:
an optical sensor, said optimal sensor being adjacent to said window.

8. The device recited in claim 7, wherein said predetermined quantity of channels of the multichannel array are aligned in an optical path between the optical sensor and a target.

9. The device recited in claim 8, wherein the target is one of a plasma ignited with said process volume and the substrate.

10. The device recited in claim 7, wherein the window chamber gas is an inert gas.

11. The device recited in claim 7, wherein the window chamber gas is the process gas.

12. The device recited in claim 1, wherein the cross-sectional shape is symmetrical and the channel diameter is a shortest path across any symmetry axis.

13. The device recited in claim 12, wherein the cross-sectional shape is elliptical.

14. The device recited in claim 13, wherein the cross-sectional shape is circular.

15. The device recited in claim 12, wherein the cross-sectional shape is polygonal.

16. The device recited in claim 16, wherein the cross-sectional shape is one of a triangle, quadrilateral, square, rectangle, pentagon, hexagon, heptagon, octagon, nonagon, decagon or a combination of shapes.

17. A method for reducing window clouding in a viewport window of a process chamber, comprising:
providing a process chamber with a process volume operating at a process pressure;
providing a viewport window on a wall of the process chamber,
providing a multichannel array on the wall of a process chamber and adjacent to the viewport widow;
providing a predetermined number of channels in the multichannel array, each of said channels having interior end adjacent to the viewport window, and exterior end, a diameter and a length between the interior and exterior ends;
establishing a flow across the predetermined quantity of channels by exerting a gas pressure on the interior end of the predetermined quantity of channels.

18. The method recited in claim 17, wherein the window pressure is greater than the process pressure.

19. The method recited in claim 18, further comprises:
providing a process flow rate in the process volume from process gas entering the process chamber at an ingress port and gas exiting the process chamber at an egress port;
wherein the viscous flow rate is less than the process flow rate.

20. The method recited in claim 17, wherein viscous flow rate is related to the viscosity of a gas at the open end of the predetermined quantity of channels, the predetermined quantity of channels, the channel diameter of the predetermined quantity of channels, the length of the predetermined quantity of channels and a difference in pressure between the gas pressure on the interior end of the predetermined quantity of channels and the process pressure.

21. The device recited in claim 1, wherein the flow rate across the predetermined quantity of channels is a viscous flow.

22. The device recited in claim 1, wherein the window chamber gas is neither an inert gas or a process gas.

23. The method recited in claim 17, wherein the flow across the predetermined quantity of channels is a viscous flow.
